(19) United States
(12) Patent Application Publication
(10) Pub. No.: US 2018/0234003 A1
(43) Pub. Date: Aug. 16, 2018

(54) ELECTROMAGNETIC IMPACT DRIVE

(71) Applicant: Benteler Maschinenbau GmbH, 33602 Bielefeld (DE)

(72) Inventors: Anton Frank, Paderborn (DE); GEORG FROST, Steinheim (DE); FRANK RABE, Hiddenhausen (DE); MARTIN HESSELMANN, Willebadessen (DE)

(73) Assignee: Benteler Maschinenbau GmbH, 33602 Bielefeld (DE)

(21) Appl. No.: 15/894,511

(22) Filed: Feb. 12, 2018

(30) Foreign Application Priority Data
Feb. 13, 2017 (DE) 10 2017 102 835.8

(51) Int. Cl. H02K 41/03

(52) U.S. Cl. CPC H02K 41/031

(57) ABSTRACT

An electromagnetic impact drive includes two electroconductive helical springs in meshing relationship, with their fixed ends supported on an abutment and their movable ends joined to an electroconductive armature. Electric terminals connect the fixed ends to a electricity source for feeding a current to flow from one of the electric terminals via an associated one of the helical springs in a first direction towards the armature and from there in an opposite second direction via the other one of the helical springs to the other one of the electric terminals so that adjacent windings of the helical springs repel one another by an oppositely directed force pair when an electric circuit is closed. A control device is provided to open and close the electric circuit with the electricity source.

### CROSS-REFERENCES TO RELATED APPLICATIONS

This application claims the priority of German Patent Application, Serial No. 10 2017 102 835.8, filed February 13, 2017, pursuant to 35 U.S.C. 119(a)-(d), the disclosure of which is incorporated herein by reference in its entirety as if fully set forth herein.

### BACKGROUND OF THE INVENTION

The present invention relates to an electromagnetic impact drive for a tool to be moved in a linear direction.

The following discussion of related art is provided to assist the reader in understanding the advantages of the invention, and is not to be construed as an admission that this related art is prior art to this invention.

Hydraulic, pneumatic or pyrotechnic drives, or drives exploiting the effect of a combustion force, are known for their use in the field of non-thermal punching, perforating, cutting or joining of articles of a solid material having a crystalline, part-crystalline, or amorphous microstructure, and include a forming, cutting, setting or joining tool guided at a great surface penetration rate in terms of a heat propagation speed of the article. The drives for thrusting the forming, cutting, setting, or joining tools typically accelerate a mass, e.g. an impact body in the form of a hammer, striker pin or drive-fitted bolt with hard impact surface, for transmitting a kinetic impulse, caused by the impact, onto the hard surface of a tool body or article to be moved.

Impact drives require for their operation the supply of liquids or gases which are under an operating pressure and, if need be, combustible, or the use of an explosive fuel contained in a container, as well as removal and return of relieved fluids or reactive products or waste gas. Furthermore, fluid-operated or pyro-mechanical transducers and internal combustion engines are normally more difficult to control or to monitor and have lesser efficiency when compared to an electromagnetic actuator which can easily be installed in a machine tool. Also, an electromagnetic actuator is subject to less mechanical, thermal and chemical stress when compared to fluid-operated or pyro-mechanical transducers and internal combustion engines.

It would therefore be desirable and advantageous to provide an improved electromagnetic impact drive which obviates prior art shortcomings and which is compact for use in a machine tool and yet is very efficient and has substantial power density for a periodically repeating reversing operation.

### SUMMARY OF THE INVENTION

According to one aspect of the present invention, an electromagnetic impact drive for a tool to be moved in a linear direction includes two electroconductive helical springs in meshing relationship, with the helical springs having fixed ends and movable ends, a tappet movable in the linear direction, an abutment connected to the tappet and configured for support of the fixed ends, an electroconductive armature to which the movable ends are commonly joined in an electroconductive manner, an electricity source, electric terminals configured to connect the fixed ends to the electricity source for feeding a current to flow from one of the electric terminals via an associated one of the helical springs in a first direction towards the armature and from there in an opposite second direction via the other one of the helical springs to the other one of the electric terminals so that adjacent windings of the helical springs repel one another by an oppositely directed force pair when an electric circuit is closed, and a control device configured to open and close the electric circuit with the electricity source.

An electromagnetic impact drive in accordance with the present invention can find application for tools to be moved linearly and in particular for tools for punching, perforating, cutting and joining of articles. The impact drive superimposes hereby two operating principles: On the one hand, the mechanical force caused by the electricity of the helical springs, and on the other hand the presence of two conductors in the form of two interengaging helical springs through which an electric current flows and which are electroconductively connected on one end by a short-circuiting link (armature). This short-circuiting link, designated as armature, is linearly movable. The windings which carry current in opposite direction repel each other as a result of the magnetic field caused by the electric current. As a consequence, a distance between adjacent windings of the helical springs increases and the movable ends are accelerated with the armature via a limited travel path. The presence of slight travel paths is sufficient for the intended application in a machine tool, especially for punching metal sheets.

An electromagnetic impact drive in accordance with the present invention is of compact construction and reversible by opening or switching over the electric circuit via the control device, so that the electric current is guided from the electric terminals to the fixed ends in a same direction via the helical springs to a terminal of the armature. The windings of the helical springs, carrying current in a same direction, attract each other as a result of the magnetic fields induced by the current. Thus, the distance between the windings decreases. Operation of the impact drive causes little wear, and can easily be controlled and monitored. Universal operation with electric direct voltage or alternate voltage is possible. In addition, an electromagnetic impact drive in accordance with the present invention operates very effectively in comparison with other electromagnetic linear drives with limited travel path. Power density is also substantial and space requirement is therefore slight. A further benefit of an electromagnetic impact drive in accordance with the present invention is the absence of substantial mechanical, thermal, and chemical fluctuating and peak loads.

According to another advantageous feature of the present invention, an assembly comprised of the helical springs and the armature together with the contact pieces for feeding the electricity can be made in one piece as molded casting, powder-sintering piece, free-flowing (3D) laser-sintering piece, or as melt-application piece, or as a 3D milling piece produced by a material-removing shaping process. Examples of suitable materials for such an assembly include metals with good electric conductivity, great mechanical tensile strength and, if possible, no permanent magnetization. Examples of metals include aluminum, copper, nickel, silver, and alloys thereof.

The tappet may be made of several parts or different materials to realize a lightweight construction. The tappet may assume the function of a linear guidance of the electromagnetic impact drive and may include a chuck for accepting a tool, e.g. a cutting punch.

An electromagnetic impact drive in accordance with the present invention can, in principle, find application instead for cutting tools also for other machining processes, such as, e.g., setting of bolts, nails or rivets. It may also find application in machines that are not or only indirectly used for the production of workpieces, e.g. for a striking impactor testing stand.

According to another advantageous feature of the present invention, the helical springs can be configured in surrounding relation to the tappet. As the tappet is thus accommodated within an interior space that is bounded by the helical springs, a particular space-saving construction is realized. The concentric arrangement of tappet and helical springs decreases the formation of bending moments as opposed to eccentric tappets arranged axis-parallel to the armature. The tappet extends through the armature, advantageously in midsection. The tappet may also have a split configuration having functional portions on both sides of the armature.

According to another advantageous feature of the present invention, linear bearings can be provided for guiding the tappet, with one of the linear bearings being arranged adjacent to a bump stop. Advantageously, the armature or the tappet can contact the bump stop when moving out. This is required to limit the travel path. The presence of a shock-absorbing end stop is desired for safety reasons, in particular when helical springs are involved which press against the bump stop without the presence of a force that is generated by magnetic fields caused by the electric current.

According to another advantageous feature of the present invention, the helical springs can be maintained under tension. Advantageously, a return device is provided to move the tappet from a move-out position to a starting position. The tappet is greatly accelerated from the starting position, with the spring force of the biased helical springs and the electromagnetic forces between adjacent windings of the helical springs superimposing one another to establish the impact force. The return device may be constructed as a linear drive, e.g. a pneumatic cylinder with retractable piston which is connected directly or indirectly via a coupling to the tappet.

According to another advantageous feature of the present invention, the armature may include a terminal for a polarity in a same direction of the helical springs to allow electromagnetic attraction of adjacent windings of the helical springs. Thus, the helical springs can retract and the tappet can be pulled back.

According to another advantageous feature of the present invention, at least one of the helical springs can include an electrically insulating coat. By electrically insulating the helical springs against one another, proper operation is ensured, because the occurrence of a shorting between the windings of the helical springs is prevented. Advantageously, both helical springs are provided with an electrically insulating coat, so that the armature remains as the only electroconductive connection between the helical springs.

According to another advantageous feature of the present invention, an electrically insulating housing made of plastic can be provided to accommodate the helical springs and the armature. The plastic housing is provided merely for insulation purposes. The bump stop absorbs the thrust forces applied by the tappet. For this purpose an additional housing may be provided between the abutment and the free end of the tappet and assume the function of an outer housing of the impact drive.

According to another advantageous feature of the present invention, the helical springs can be produced from flat wire having flat surfaces of greater edge length disposed between the windings. As a result of such a configuration, installation space can be saved and adjacent windings can be directed relative to one another in plan-parallel manner. Greater winding numbers and greater magnetic flux densities with respect to installation space become possible, as opposed to the use of helical springs with windings having a triangular or circular cross section or those that have flattened sides with the smaller edge length between the windings.

According to another advantageous feature of the present invention, a retention device can be provided to secure the tappet in the starting position, after the tappet has moved back by a return device or as a result of a polarity reversal of the conduction direction in one of the two helical springs. Advantageously, the retention device can include a releasable catch which can engage a locking lug of the tappet.

According to another advantageous feature of the present invention, the retention device can include a coupling configured to effect a magnetic, pneumatic, hydraulic or mechanical interference fit between the tappet and the outer housing. The impact drive can be activated, when releasing the retention device.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of the railgun principle;

FIG. 2 is a schematic illustration of the drive principle of an impact drive according to the present invention;

FIG. 3 is a simplified illustration of an exemplified embodiment of an impact drive according to the present invention in combination with a cutting punch; and

FIG. 4 is a block diagram showing the relationship of various components.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

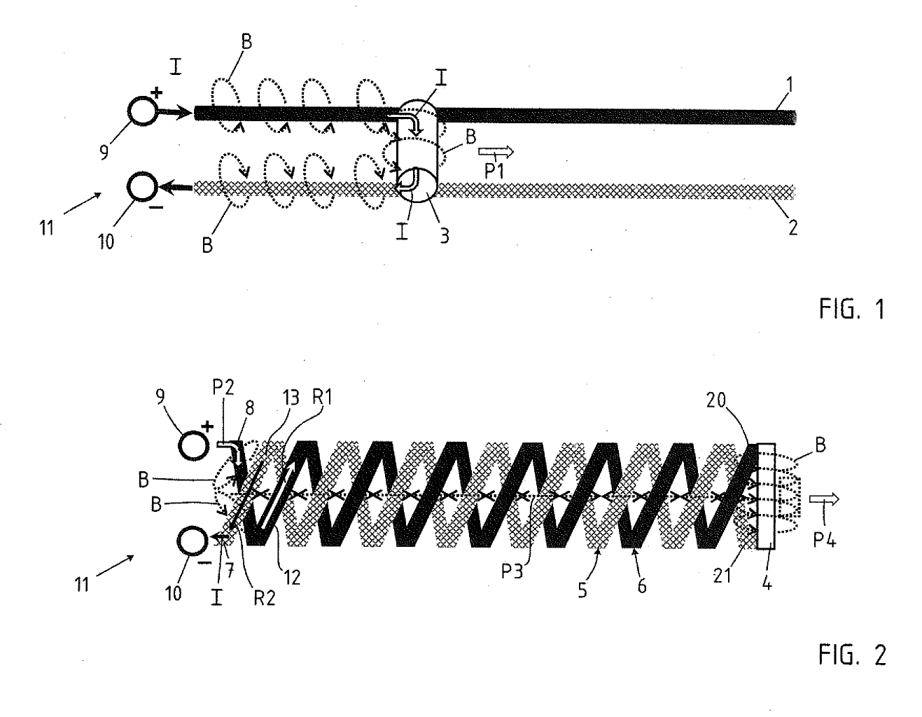

Turning now to the drawing, and in particular to FIG. 1, there is shown a schematic illustration of the railgun principle. Two parallel electroconductive rails 1, 2 are connected via electric terminals 9, 10 to an electricity source 11. The two rails 1, 2 are electroconductively shorted by a runner 3. The runner 3 is mounted in relation to the rails 1, 2 for movement in a direction of arrow P1. When applying an electric current I via the rails 1, 2 and the runner 3, the rails 1, 2 and the runner 3 are surrounded by a magnetic flux density B. A Lorentz force is produced to move the runner 3 in a direction of arrow P1 through the magnetic field that is perpendicular to the direction of the electric current. The runner 3 is hereby accelerated. This is the principle of railgun technology.

Referring now to FIG. 2, there is shown a schematic illustration of the drive principle of an impact drive according to the present invention, with the difference to the railgun principle according to FIG. 1 residing in the impact drive including an armature 4 which is firmly secured to two electroconductive helical springs 5, 6 having windings 12, 13 in meshing relationship. The helical springs 5, 6 have a same length and a same diameter and intermesh over their entire length, as is readily apparent from FIG. 2.

The helical springs 1, 2 have fixed ends 7, 8, which are shown in FIG. 2 on the left-hand side and connected via electric terminals 9, 10 to a connectable electricity source 11. As a result, an electric current I is fed in a direction of arrow P2 into one of the two helical springs, here helical spring 6. The electric current I flows via the armature 4 to the second helical spring 5 and from there via the fixed end 7 to the other electric terminal 10 of the electricity source 11, As a result of the electric current I and the moved charge, the windings 12, 13 are surrounded by a magnetic flux density B. The magnetic fields follow the electric current path and thus form a helical course like the windings 12, 13. As the current I flows through the helical springs 5, 6 and thus the windings 12, 13 in opposite directions, as indicated by arrows R1, R2, also the induced magnetic fields with the magnetic flux density B are directed in opposite direction and repel each other. This effect is shown in FIG. 2 by arrows P3 which are plotted as resultant on the center longitudinal axis of the helical springs 5, 6. The repulsive forces add up so that the helical springs 5, 6 are elastically deformed under the influence of the repulsive forces. The armature 4 is moved by the moving ends 20, 21 of the helical springs 5, 6 together with the moving ends 20, 21 in a direction of arrow P4 to the right in the drawing plane. Unlike in the railgun principle, shown in FIG. 1, the armature 4 remains connected to the helical springs 5, 6. When no electric current I is delivered from the electricity source 11, the magnetic field collapses and the helical springs 5, 6 are subject only to the adjustment force generated by the electric deflection from the idle position.

The helical springs 5, 6 involve advantageously flat helical compression springs which are maintained under tension in their starting position (not shown). Thus, when the impact drive is activated, a mechanical spring force of the helical springs 5, 6 and the electromagnetic force superimpose, when the effective direction is the same, so that the armature 4 is launched at high acceleration in shortest possible time. As a result, the stroke paths for accelerating the tappet are very short. The assembly is thus very compact.

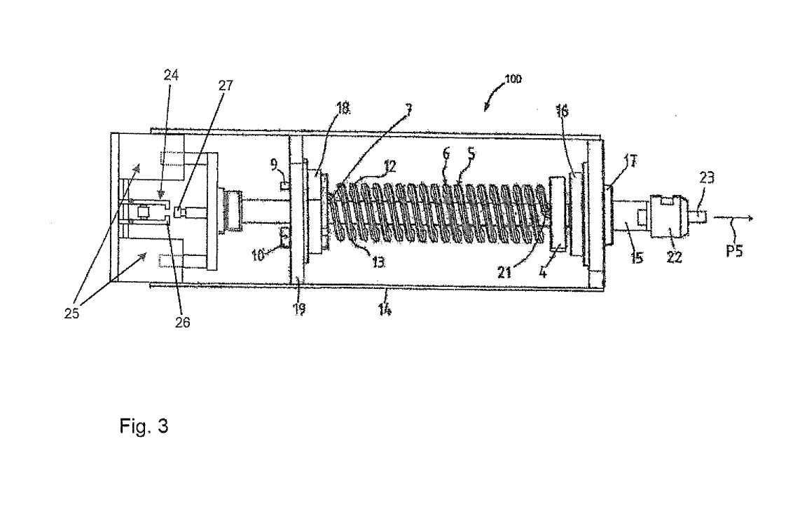

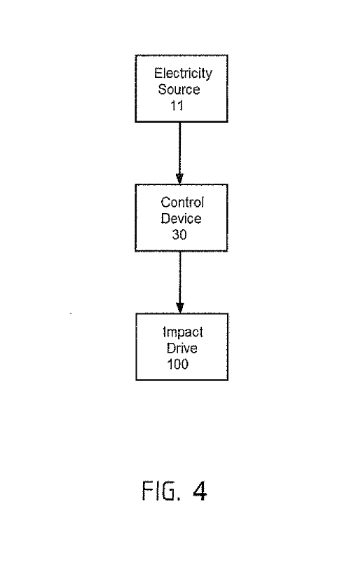

Turning now to FIG. 3, there is shown a simplified constructive illustration of an exemplified embodiment of an impact drive according to the present invention, generally designated by reference numeral 100. Parts corresponding with those in FIG. 2 are denoted by identical reference numerals and not explained again. The impact drive 100 includes an electrically insulated housing 14 and an armature 4 accommodated in the housing 14. The armature 4 is electroconductively connected to two helical springs 5, 6. Wiring of the helical springs 5, 6 corresponds to the one shown in FIG. 2. The helical springs 5, 6 surround a tappet 15 which is mounted within the housing 15 for linear movement. The armature 4 is coupled for force transmission with the movable end 21 of the helical spring 6, with the movable end 20 (invisible in FIG. 3) of the helical spring 5, and with the tappet 15. The tappet 15 touches in its move-out position a bump stop 16. Arranged adjacent to the bump stop 16 on a housing side distal to the armature 4 is a linear bearing 17 for support of the tappet 15 in relation to the housing 14. A further linear bearing 18 is arranged adjacent to the fixed ends 7 of the helical springs 5, 6 and held against an abutment 19 via which impact forces exerted by the impact drive in a direction of arrow P5 are received and transmitted to the housing 14. Electric terminals 9, 10 are arranged on the abutment 19 at a side distal to the linear bearing 18 for allowing feeding of an electric current I. A control device 30, shown in FIG. 4, controls the current flow to the impact drive 100 by closing or opening the electric circuit via the helical springs 5, 6 and the armature 4.

In the non-limiting example of FIG. 3, the tappet 15 of the impact drive 100 has a chuck 22 at one end for accepting a cutting punch 23. Such an impact drive 100 is suitable in particular for adiabatic cutting. As is further shown schematically, a retention device 24 can be provided to secure the tappet 15 in the starting position, after the tappet 15 has moved back by a return device 25 or as a result of a polarity reversal of the conduction direction in one of the two helical springs. The retention device 24 can include a releasable catch 26 which can engage behind a locking lug 27 of the tappet 15.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An electromagnetic impact drive for a tool to be moved in a linear direction, said impact drive comprising:
two electroconductive helical springs in meshing relationship, said helical springs having fixed ends and movable ends;
a tappet movable in the linear direction;
an abutment connected to the tappet and configured for support of the fixed ends;
an electroconductive armature to which the movable ends are commonly joined in an electroconductive manner;
an electricity source;
electric terminals configured to connect the fixed ends to the electricity source for feeding a current to flow from one of the electric terminals via an associated one of the helical springs in a first direction towards the armature and from there in an opposite second direction via the other one of the helical springs to the other one of the electric terminals so that adjacent windings of the helical springs repel one another by an oppositely directed force pair, when an electric circuit is closed; and
a control device configured to open and close the electric circuit with the electricity source.

2. The impact drive of claim 1, wherein the helical springs are configured in surrounding relation to the tappet.

3. The impact drive of claim 1, wherein the helical springs are maintained under tension in a direction of applying a spring force which together with the electromagnetic force acting between the windings of the helical springs are superimposable upon one another to establish an impact force upon the tappet.

4. The impact drive of claim 1, wherein the tappet includes a chuck for accepting a tool.

5. The impact drive of claim 1, further comprising a return device to move the tappet from a move-out position to a starting position.

6. The impact drive of claim 1, wherein the armature includes a terminal for a same polarity of the helical springs to allow electromagnetic attraction of adjacent windings of the helical springs.

7. The impact drive of claim 1, further comprising a bump stop contacted by the armature or tappet in their end position.

8. The impact drive of claim 7, further comprising linear bearings for guiding the tappet, with one of the linear bearings being arranged adjacent to the bump stop.

9. The impact drive of claim 1, wherein at least one of the helical springs includes an electrically insulating coat.

10. The impact drive of claim 1, wherein the tappet has a tubular configuration.

11. The impact drive of claim 1, wherein the helical springs and the armature are made in one piece and of same material.

12. The impact drive of claim 1, wherein the helical springs and the armature are made of at least one metal selected from the group consisting of aluminum, copper, nickel, silver, and alloys thereof.

13. The impact drive of claim 1, wherein the helical springs and the armature are made of tin-bronze CuSn6.

14. The impact drive of claim 1, further comprising an electrically insulating housing made of plastic and accommodating the helical springs and the armature.

15. The impact drive of claim 1, wherein the helical springs are produced from flat wire having fiat surfaces disposed between the windings.

16. The impact drive of claim 14, further comprising a retention device to secure the tappet in a move-in position upon the housing.

17. The impact drive of claim 16, wherein the retention device includes a releasable catch.

18. The impact drive of claim 16, wherein the retention device includes a coupling configured to effect a magnetic, pneumatic, hydraulic or mechanical interference fit between the tappet and the housing.
